(19) United States
(12) Patent Application Publication
(10) Pub. No.: US 2012/0226455 A1
(43) Pub. Date: Sep. 6, 2012

(54) Anomalously Charged State Detection Device and Test Method for Lithium Secondary Cell

(75) Inventors: Yoshiaki KUMASHIRO, Kasama-shi (JP); Tsunenori Yamamoto, Hitachi-shi (JP); Osamu Kubota, Naka-gun (JP)

(73) Assignee: Hitachi, Ltd., Tokyo (JP)

(21) Appl. No.: 13/407,827

(22) Filed: Feb. 29, 2012

(30) Foreign Application Priority Data
Mar. 1, 2011 (JP) 2011-043465

(51) Int. Cl. G06F 19/00

(52) U.S. Cl. 702/63

(57) ABSTRACT

A lithium secondary cell has a positive electrode, a negative electrode, and an electrolyte including lithium ions. An anomalously charged state detection device includes: a voltage detection unit; a current detection unit; a calculation unit that calculates the electricity amount Q charged into or discharged from the lithium secondary cell and a differential value dV/dQ for each predetermined time period t, and that obtains a Q-dV/dQ curve; a measured data storage unit that stores the Q-dV/dQ curve; a cell data storage unit that stores a Q-dV/dQ curve during normal conditions; and a control unit that decides that the lithium secondary cell is in an anomalously charged state if, in the Q-dV/dQ curve stored by the measured data storage unit, a peak is present that is different from a peak that appears in the Q-dV/dQ curve during normal conditions.

### INCORPORATION BY REFERENCE

The disclosure of the following priority application is herein incorporated by reference: Japanese Patent Application No. 2011-043465 filed on Mar. 1, 2011.

### BACKGROUND OF THE INVENTION

1. Field of the Invention

The present invention relates to an anomalously charged state detection device and a test method for a lithium secondary cell in an electrical power supply system that includes a lithium secondary cell and that supplies power to a load.

2. Description of Related Art

Since lithium secondary cells have high specific energy density, nowadays they are often used in power supplies for electric automobiles or for backup. Since a lithium secondary cell that uses graphite as the negative electrode active material can provide a high average voltage, and since it is possible to charge this negative electrode active material at high density, accordingly it is often used in applications in which high specific energy density is required. However, a lithium secondary cell that employs graphite as the negative electrode active material can easily get into an anomalously charged state due to lithium metal being precipitated out upon the negative electrode by repeated charging and discharging. As a result, the capacity tends to drop along with the repetition of charging and discharging cycles.

There is one method for detecting the state of a secondary cell that uses a Q-V curve that is obtained from the charged electricity amount Q of the secondary cell and the voltage V of the secondary cell, and a Q-dV/dQ curve that is obtained from the charged electricity amount Q, the amount of change dQ of the charged electricity amount Q in a predetermined time interval, and the corresponding amount of change dV of the voltage V. In Japanese Laid-Open Patent Publication 2009-252381, for example, there is disclosed a secondary cell system in which the state of deterioration of a secondary cell is detected by calculating the difference value ΔQ between the charged electricity amount QA at a characteristic point A and the charged electricity amount QC at a characteristic point C on the Q-dV/dQ curve for the secondary cell that has deteriorated, and comparing this difference value ΔQ with an initial value for this secondary cell in its initial state.

However, with the secondary cell system described above, the values of the difference between the charged electricity amounts at the characteristic points on the Q-dV/dQ curve of the lithium secondary cell are compared while excluding an anomalously charged state, so that no consideration to a characteristic point that appears in an anomalous state of the lithium secondary cell is given. Due to this, although it is possible to diagnose the state of deterioration of the lithium secondary cell, it is not possible to detect an anomalously charged state of the lithium secondary cell.

### SUMMARY OF THE INVENTION

The object of the present invention is to solve problems of the type described above, and to provide an anomalously charged state detection device for a lithium secondary cell that can enhance the security of the lithium secondary cell.

An anomalously charged state detection device according to a first aspect of the present invention for a lithium secondary cell that has a positive electrode, a negative electrode, and an electrolyte including lithium ions, and that is capable of being electrically charged and discharged, includes: a voltage detection unit that detects the voltage V of the lithium secondary cell; a current detection unit that detects the current flowing in the lithium secondary cell; a calculation unit that calculates the electricity amount Q charged into or discharged from the lithium secondary cell on the basis of the current value detected by the current detection unit and a differential value dV/dQ, which is the proportion between the change dV of the voltage V and the change dQ of the electricity amount Q, for each predetermined time period t on the basis of the electricity amount Q and the voltage V, and that obtains a Q-dV/dQ curve for the lithium secondary cell; a measured data storage unit that stores the Q-dV/dQ curve for the lithium secondary cell obtained by the calculation unit; a cell data storage unit that stores a Q-dV/dQ curve for the lithium secondary cell during normal conditions; and a control unit that decides that the lithium secondary cell is in an anomalously charged state if, in the Q-dV/dQ curve for the lithium secondary cell stored by the measured data storage unit, a peak is present that is different from a peak that appears in the Q-dV/dQ curve during normal conditions stored by the cell data storage unit.

According to a second aspect of the present invention, in the anomalously charged state detection device of the first aspect for a lithium secondary cell, it is preferred that: the negative electrode of the lithium secondary cell includes graphite; and, in order, a first peak, a second peak, and a third peak appear in the Q-dV/dQ curve during normal conditions, at positions where the amount of lithium ions occluded in the graphite changes from high to low.

According to a third aspect of the present invention, in the anomalously charged state detection device of the second aspect for a lithium secondary cell, when the lithium secondary cell is discharged from the charged state, the control unit may decide that the lithium secondary cell is in the anomalously charged state if a higher peak in the differential value dV/dQ than the first peak has been detected in a region in the Q-dV/dQ curve of the lithium secondary cell where the electricity amount Q is smaller than the first peak.

According to a fourth aspect of the present invention, in the anomalously charged state detection device of the second aspect for a lithium secondary cell, when the lithium secondary cell is charged from the discharged state, the control unit may decide that the lithium secondary cell is in the anomalously charged state if a higher peak in the differential value dV/dQ than the first peak has been detected in a region in the Q-dV/dQ curve of the lithium secondary cell where the electricity amount Q is larger than the first peak.

According to a fifth aspect of the present invention, in the anomalously charged state detection device of any one of the first through fourth aspects for a lithium secondary cell, the anomalously charged state may be a state in which metallic lithium has been precipitated out upon the negative electrode of the lithium secondary cell.

According to a sixth aspect of the present invention, in the anomalously charged state detection device of any one of the first through fifth aspects for a lithium secondary cell, it is preferred that the negative electrode of the lithium secondary cell includes a negative electrode active material containing graphite for which the gaps between its surfaces (002), as obtained by an X-ray diffraction method, are d002=0.335 to 0.349 nm.

According to a seventh aspect of the present invention, in the anomalously charged state detection device of any one of the first through sixth aspects for a lithium secondary cell, the positive electrode of the lithium secondary cell may include a positive electrode active material containing at least a lithium containing transition metallic compound oxide having an olivine crystal structure.

According to an eighth aspect of the present invention, in the anomalously charged state detection device of the seventh aspect for a lithium secondary cell, it is preferred that the positive electrode active material includes a lithium containing transition metallic compound oxide having an olivine crystalline structure, the transition metallic compound oxide being chemically described as Li₁₊ₓM₁₋ₓPO₄ (where M is one or more transition metallic elements selected from Mn, Co, Ni, Cr, Al, Mg, and Fe).

According to a ninth aspect of the present invention, in the anomalously charged state detection device of any one of the first through eighth aspects for a lithium secondary cell, the cell data storage unit may store in advance a plurality of Q-dV/dQ curves during normal conditions for various current values; and the control unit may select, from among the plurality of Q-dV/dQ curves during normal conditions stored by the cell data storage unit, the Q-dV/dQ curve during normal conditions that corresponds to the current value detected by the current detection unit, and decide whether or not the lithium secondary cell is in the anomalously charged state on the basis of this Q-dV/dQ curve during normal conditions that has been selected.

According to a tenth aspect of the present invention, the anomalously charged state detection device of any one of the first through ninth aspects for a lithium secondary cell may further include a temperature measurement unit that measures the temperature of the surroundings of the lithium secondary cell. In this anomalously charged state detection device, it is preferred that: the cell data storage unit stores in advance a plurality of Q-dV/dQ curves during normal conditions for various temperatures of the surroundings of the lithium secondary cell; and the control unit selects, from among the plurality of Q-dV/dQ curves during normal conditions stored by the cell data storage unit, the Q-dV/dQ curve during normal conditions that corresponds to the temperature of the surroundings of the lithium secondary cell measured by the temperature measurement unit, and decides whether or not the lithium secondary cell is in the anomalously charged state on the basis of this Q-dV/dQ curve during normal conditions that has been selected.

An anomalously charged state test method according to an eleventh aspect of the present invention for a lithium secondary cell that has a positive electrode, a negative electrode, and an electrolyte including lithium ions, and that is capable of being electrically charged and discharged, includes: acquiring the current value and the voltage value V of the lithium secondary cell for each predetermined time period; calculating the electricity amount Q charged into or discharged from the lithium secondary cell on the basis of the current value of the lithium secondary cell; calculating a differential value dV/dQ, which is the proportion between the change dV of the voltage V and the change dQ of the electricity amount Q, for each predetermined time period t on the basis of the electricity amount Q and the voltage V; obtaining a Q-dV/dQ curve for the lithium secondary cell; and deciding that the lithium secondary cell is in an anomalously charged state if, in the Q-dV/dQ curve for the lithium secondary cell, a peak is present that is different from a peak that appears in a Q-dV/dQ curve during normal conditions for the lithium secondary cell that has been acquired in advance.

According to a twelfth aspect of the present invention, in the anomalously charged state test method of the eleventh aspect for a lithium secondary cell, it is preferred that: the negative electrode of the lithium secondary cell includes graphite; and, in order, a first peak, a second peak, and a third peak appear in the Q-dV/dQ curve during normal conditions, at positions where the amount of lithium ions occluded in the graphite changes from high to low.

According to a thirteenth aspect of the present invention, in the anomalously charged state test method of the twelfth aspect for a lithium secondary cell, when the lithium secondary cell is discharged from the charged state, it may be decided that the lithium secondary cell is in the anomalously charged state if a higher peak in the differential value dV/dQ than the first peak has been detected in a region in the Q-dV/dQ curve of the lithium secondary cell where the electricity amount Q is smaller than the first peak.

According to a fourteenth aspect of the present invention, in the anomalously charged state test method of the twelfth aspect for a lithium secondary cell, when the lithium secondary cell is charged from the discharged state, it may be decided that the lithium secondary cell is in the anomalously charged state if a higher peak in the differential value dV/dQ than the first peak has been detected in a region in the Q-dV/dQ curve of the lithium secondary cell where the electricity amount Q is larger than the first peak.

According to a fifteenth aspect of the present invention, in the anomalously charged state test method of any one of the eleventh through fourteenth aspects for a lithium secondary cell, the anomalously charged state may be a state in which metallic lithium has been precipitated out upon the negative electrode of the lithium secondary cell.

According to a sixteenth aspect of the present invention, in the anomalously charged state test method of any one of the eleventh through fifteenth aspects for a lithium secondary cell, it is preferred that the negative electrode of the lithium secondary cell includes a negative electrode active material containing graphite for which the gaps between its surfaces (002), as obtained by an X-ray diffraction method, are d002=0.335 to 0.349 nm.

According to a seventeenth aspect of the present invention, in the anomalously charged state test method of any one of the eleventh through sixteenth aspects for a lithium secondary cell, the positive electrode of the lithium secondary cell may include a positive electrode active material containing at least a lithium containing transition metallic compound oxide having an olivine crystal structure.

According to an eighteenth aspect of the present invention, in the anomalously charged state test method of the seventeenth aspect for a lithium secondary cell, it is preferred that the positive electrode active material includes a lithium containing transition metallic compound oxide having an olivine crystalline structure, the transition metallic compound oxide being chemically described as Li₁₊ₓM₁₋ₓPO₄ (where M is one or more transition metallic elements selected from Mn, Co, Ni, Cr, Al, Mg, and Fe).

According to a nineteenth aspect of the present invention, in the anomalously charged state test method of any one of the eleventh through eighteenth aspects for a lithium secondary cell, a plurality of Q-dV/dQ curves during normal conditions may be stored in advance for various current values of charging or discharging; and, from among the plurality of Q-dV/dQ curves during normal conditions, the Q-dV/dQ curve during normal conditions that corresponds to the current value flowing in the lithium secondary cell may be selected, and it may be decided whether or not the lithium secondary cell is in the anomalously charged state on the basis of this Q-dV/dQ curve during normal conditions that has been selected.

According to a twentieth aspect of the present invention, in the anomalously charged state test method of any one of the eleventh through nineteenth aspects for a lithium secondary cell, it is preferred that: a plurality of Q-dV/dQ curves during normal conditions for various temperatures of the surroundings of the lithium secondary cell are stored in advance; and, from among the plurality of Q-dV/dQ curves during normal conditions, the Q-dV/dQ curve during normal conditions that corresponds to the temperature of the surroundings of the lithium secondary cell is selected, and it is decided whether or not the lithium secondary cell is in the anomalously charged state on the basis of this Q-dV/dQ curve during normal conditions that has been selected.

According to the anomalously charged state detection device for a lithium secondary cell of the present invention, it is possible to detect an anomalously charged state with high accuracy, and thus it becomes possible to enhance the security of the lithium secondary cell.

### BRIEF DESCRIPTION OF THE DRAWINGS

FIG. 1 is a block diagram of an anomalously charged state detection device for a lithium secondary cell according to an embodiment of the present invention;

FIG. 2 is a figure showing a discharge curve giving the relationship between the discharged electricity amount Q and the cell voltage V of a cell having a negative electrode made from a graphitic material, when it has been discharged at a constant discharge current from the state in which it was charged up until metallic lithium was precipitated out upon the negative electrode;

FIG. 3 is a figure showing a Q-dV/dQ curve created based on the discharge curve of FIG. 2;

FIG. 4 is a figure showing a discharge curve giving the relationship between the discharged electricity amount Q of a normal lithium cell and its cell voltage V, when it has been discharged at a constant discharge current from the fully charged state;

FIG. 5 is a figure showing a discharge curve in which the horizontal axis of the discharge curve of FIG. 4 is changed from the discharged electricity amount Q to DOD;

FIG. 6 is a figure showing a Q-dV/dQ curve created based on the discharge curve of FIG. 4;

FIG. 7 is a figure showing a DOD-dV/dQ curve created based on the discharge curve of FIG. 5;

FIG. 8 is a figure showing a discharge curve giving the relationship between the discharged electricity amount Q and the cell voltage V of a lithium secondary cell in the anomalously charged state, when it has been discharged at a constant discharge current from the fully charged state;

FIG. 9 is a figure showing a Q-dV/dQ curve created based on the discharge curve of FIG. 8;

FIG. 10 is a figure showing a DOD-dV/dQ curve created based on the discharge curve of FIG. 8; and

FIG. 11 is a flow chart showing the operation of a calculation unit of an anomalously charged state detection device for a lithium secondary cell according to an embodiment of the present invention.

### DESCRIPTION OF THE PREFERRED EMBODIMENT

In the following, the structure and the operation of an anomalously charged state detection device for a lithium secondary cell according to an embodiment of the present invention will be explained with reference to the drawings. It is to be noted that the present invention is not limited to the following embodiment.

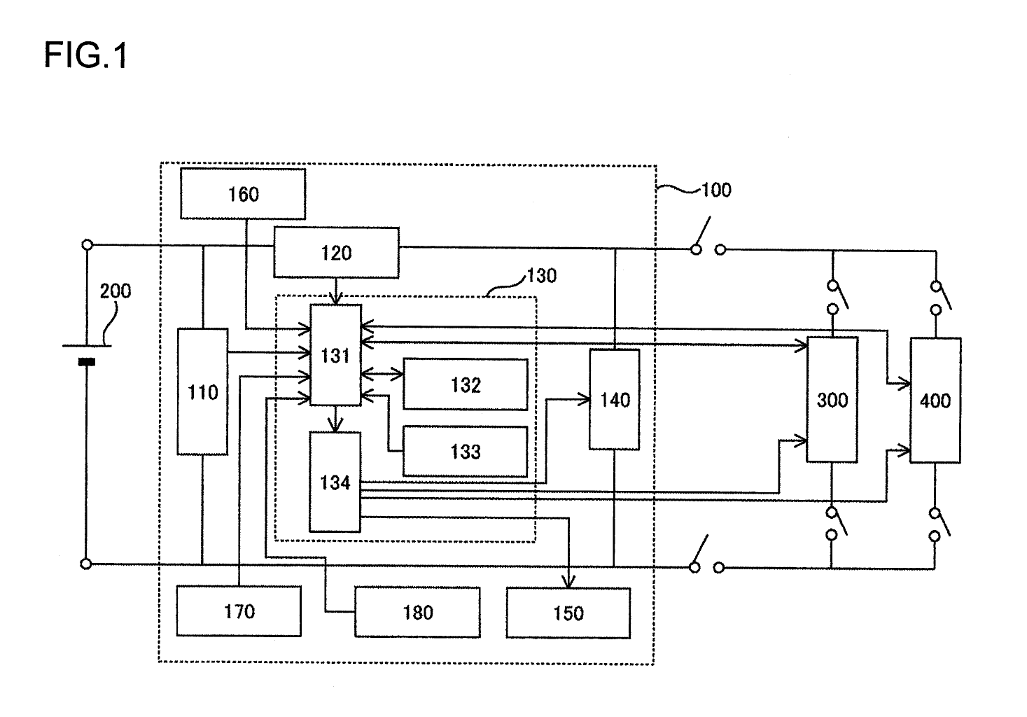

FIG. 1 is a system block diagram of an anomalously charged state detection device for a lithium secondary cell according to an embodiment of the present invention. The anomalously charged state detection device 100 of this embodiment is connected to the positive electrode terminal and to the negative electrode terminal of a lithium secondary cell 200 that is to be the subject of anomalously charged state detection. And an anomalously charged state of this lithium secondary cell 200 is detected on the basis of data that is measured during charging or discharging of the lithium secondary cell 200. By an anomalously charged state of the lithium secondary cell 200 is meant a state in which metallic lithium has been precipitated out upon the negative electrode.

As shown in FIG. 1, the anomalously charged state detection device 100 includes a voltage detection unit 110, a current detection unit 120, a calculation unit 130, a current control unit 140, a display unit 150 such as a display or the like, a temperature detection unit 160, and a condition input unit 170 such as a keyboard or a mouse or the like.

The calculation unit 130 includes a CPU 131, a measured data storage unit 132 such as a RAM or the like, a cell data storage unit 133, and an interface 134 for communicating with the exterior of the calculation unit 130.

On the basis of the electric current value I detected by the current detection unit 120, the CPU 131 calculates the electricity amount Q charged into or discharged from the lithium secondary cell 200 cyclically in each of successive predetermined time periods t. And, on the basis of this electricity amount Q, the CPU 131 calculates the amount of change dQ of the electricity amount Q for the lithium secondary cell 200 during each of the predetermined time periods t. Moreover, on the basis of the voltage value V detected by the voltage detection unit 110, the CPU 131 calculates the amount of change dV of the voltage V of the lithium secondary cell 200 during each of the predetermined time periods t. And the CPU 131 calculates the differential value dV/dQ for each of the time periods t, which is the proportional change dV with respect to the change dQ.

Then, from the values of the above electricity amount Q and the differential values dV/dQ for each of the time periods t, the CPU 131 generates a Q-dV/dQ curve for the lithium secondary cell 200. And this Q-dV/dQ curve that has been created is stored in the measured data storage unit 132. Moreover, before using the lithium secondary cell 200 in its normal state, which is not the anomalously charged state, a Q-dV/dQ curve during normal conditions is acquired, and is stored in advance in the cell data storage unit 133.

The CPU 131 compares together the shape of the Q-dV/dQ curve for the lithium secondary cell 200 that is stored in the measured data storage unit 132 and the shape of the Q-dV/dQ curve during normal conditions that is stored in advance in the cell data storage unit 133, and decides whether or not the lithium secondary cell 200 is in an anomalously charged state on the basis of the result of this comparison. And, via a communication line, the interface 134 outputs the result of this decision by the CPU 131 to one or more of, according to circumstances, a load 300, a charging device 400, the current control unit 140, and the display unit 150.

A controller, a computer system, a microcomputer or the like may, for example, be used as the calculation unit 130 described above. Any method for implementing this calculation unit may be employed, provided that it is capable of inputting information, performing calculation, and outputting the result of such calculation.

The interface 134 performs communication between the calculation unit 130 and the exterior by input and output of information via a communication line or a network that is connected to the exterior. This communication that the interface 134 performs between the calculation unit 130 and the exterior may be communication via cable, or may be wireless communication via a wireless LAN or the like.

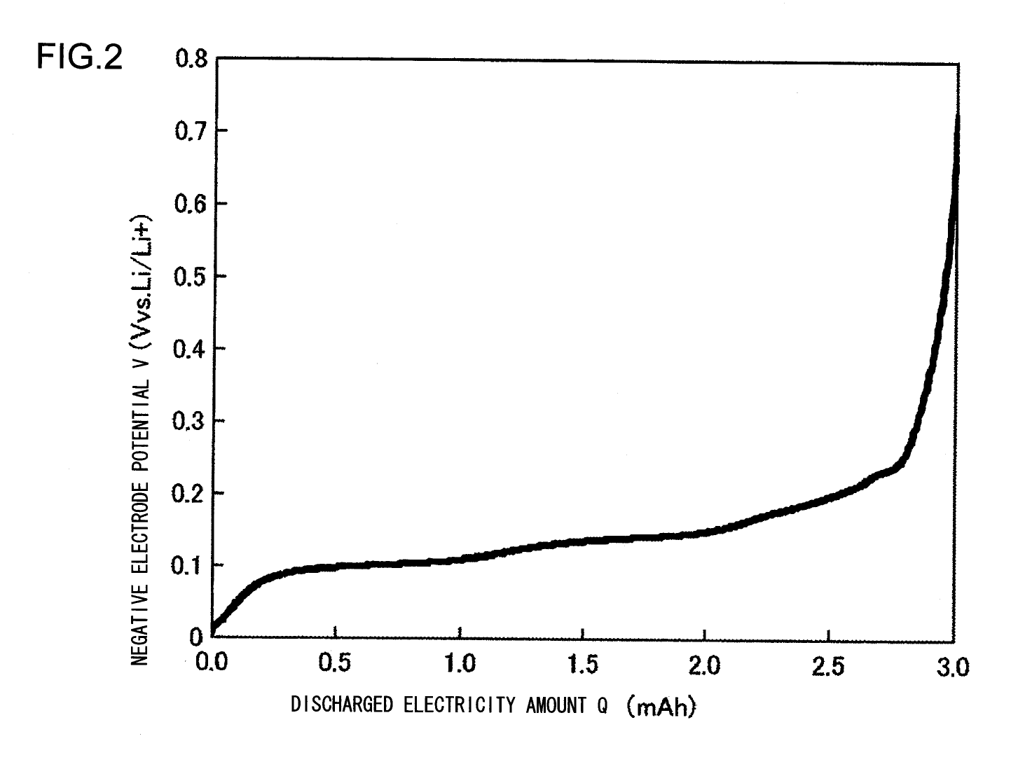

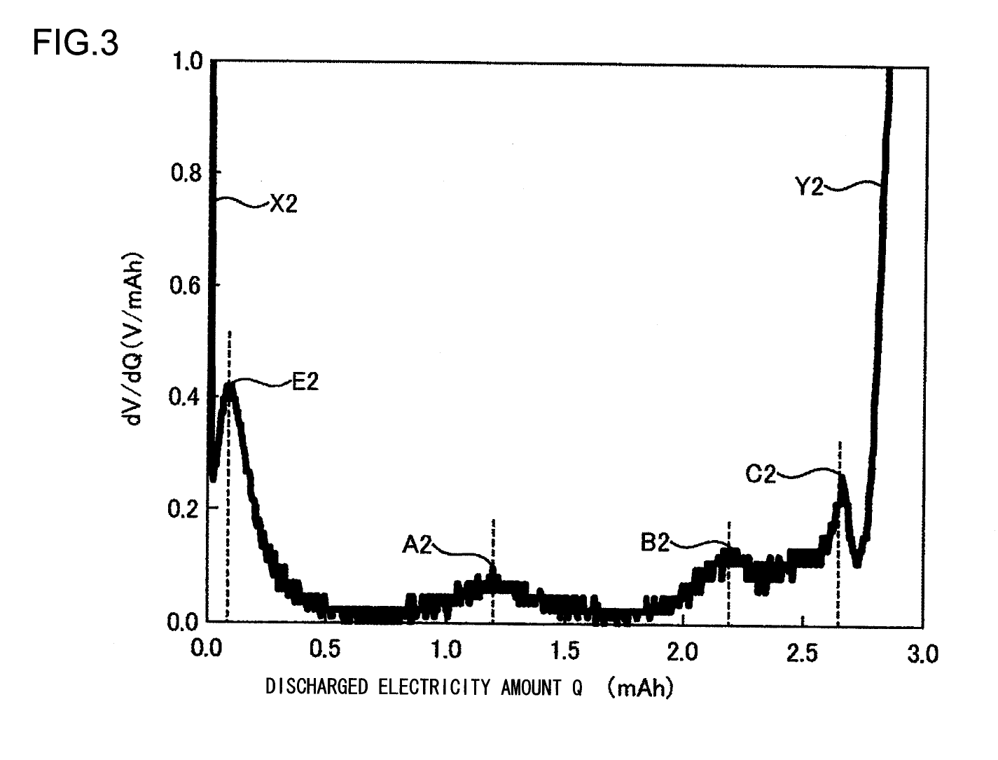

In order to perfect the invention of the anomalously charged state detection device 100 of FIG. 1, the present inventors manufactured a lithium secondary cell in the form of a three electrode type test cell in which a counter electrode and a reference electrode were made from lithium metal and a negative electrode made from graphite material was used as a working electrode. And discharge was performed at a constant discharge current, from the state in which this lithium secondary cell was charged up until metallic lithium started to precipitate out on the negative electrode. FIG. 2 shows an example of a discharge curve illustrating the relationship between the electricity amount Q discharged from the negative electrode at that time and the cell voltage V. Moreover, FIG. 3 shows a Q-dV/dQ curve created on the basis of the discharge curve of FIG. 2.

In FIG. 3, the left end shows the differential value dV/dQ when the cell is in the charged state. The negative electrode being charged means the state in which Li+ ions are occluded in the negative electrode, while the negative electrode being discharged means the state in which Li+ ions are emitted from the negative electrode. In FIG. 3, with the exception of the peaks X2 and Y2 at the two ends, four main peak shapes appear: A2, B2, C2, and E2. A2, B2, and C2 are peaks that originate due to Li+ ions being emitted from the negative electrode in the normal state, while E2 is a peak that originates due to metallic lithium precipitated upon the negative electrode being emitted. In other words, A2, B2, and C2 are peaks that appear in the normal state, while E2 is a peak that indicates the anomalously charged state. It should be understood that the amount of Li+ ions that are occluded in the graphite of the negative electrode at these peaks increases in the order A2, B2, C2.

In FIG. 3, the first peak is A2, the second peak is B2, and the third peak is C2. In the following, it will be supposed that the first peak is denoted by AN, the second peak is denoted by BN, the third peak is denoted by CN, and the peak that indicates the anomalously charged state is denoted by EN. Since the value of N distinguishes the peaks in the various figures and explained hereinafter from one another, accordingly in each figure a different natural number is substituted for N.

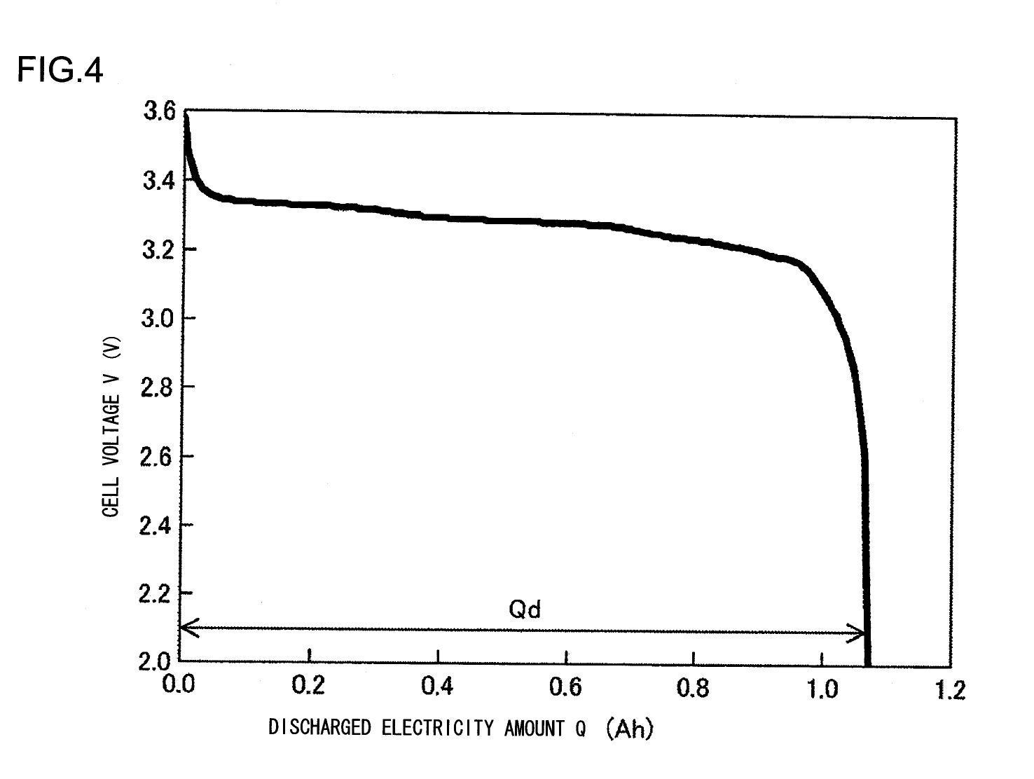

An example is shown in FIG. 4 of a discharge curve when (using a different lithium secondary cell from the one described above) this cell is in a normal state that is not the anomalously charged state. This discharge curve shows the relationship between the discharged electricity amount Q and the cell voltage V, when a lithium secondary cell in which LiFePO₄ is used for the positive electrode active material and graphite is used for the negative electrode active material is discharged at a constant discharge current from the state in which it is fully charged up to a voltage of 3.6 V.

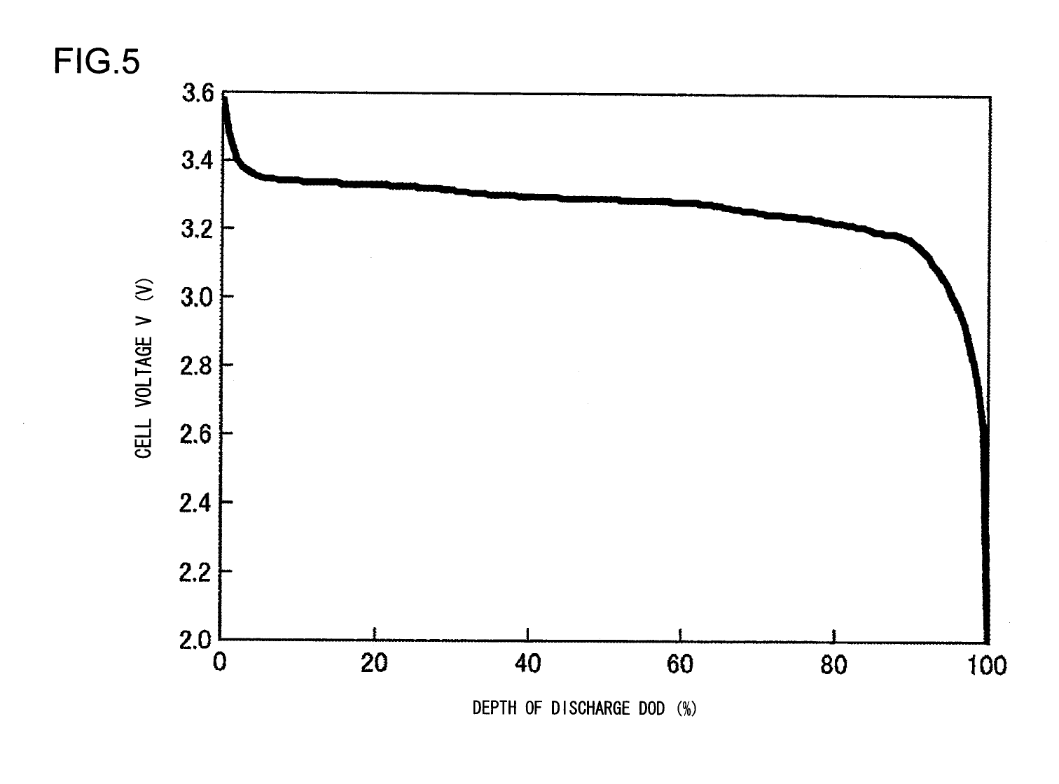

In FIG. 5, a discharge curve is shown in which the discharged electricity amount Q of FIG. 4 is replaced by the depth of discharge DOD. This depth of discharge DOD is a value expressed in percent that specifies the discharged electricity amount Q at various time points during discharge with respect to the discharged electricity amount Qd when the discharge curve of FIG. 3 reaches the cell voltage of 2 V and discharge is stopped, taking Qd as 100%. In the following, the voltage when discharge is stopped will be termed the discharge termination voltage. It should be understood that, for Qd, it would also be acceptable to substitute the charged electricity amount Qc when the lithium secondary cell is charged up fully to the voltage of 3.6 V, after having been discharged down to the cell voltage of 2 V.

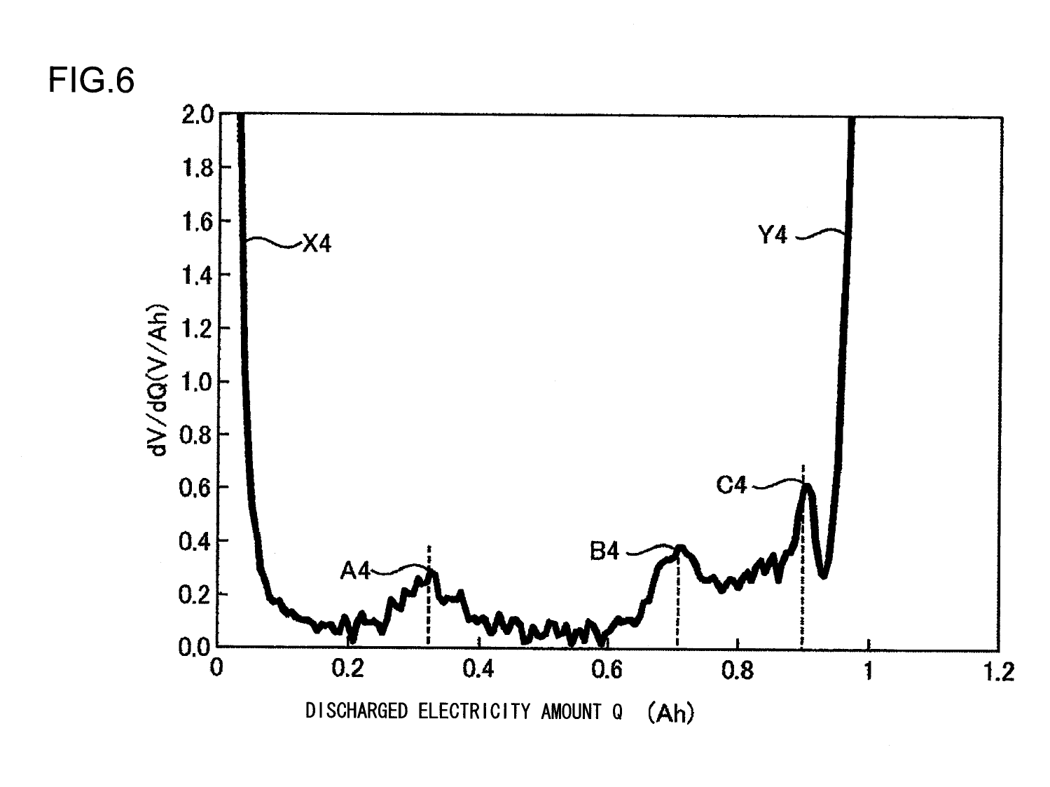

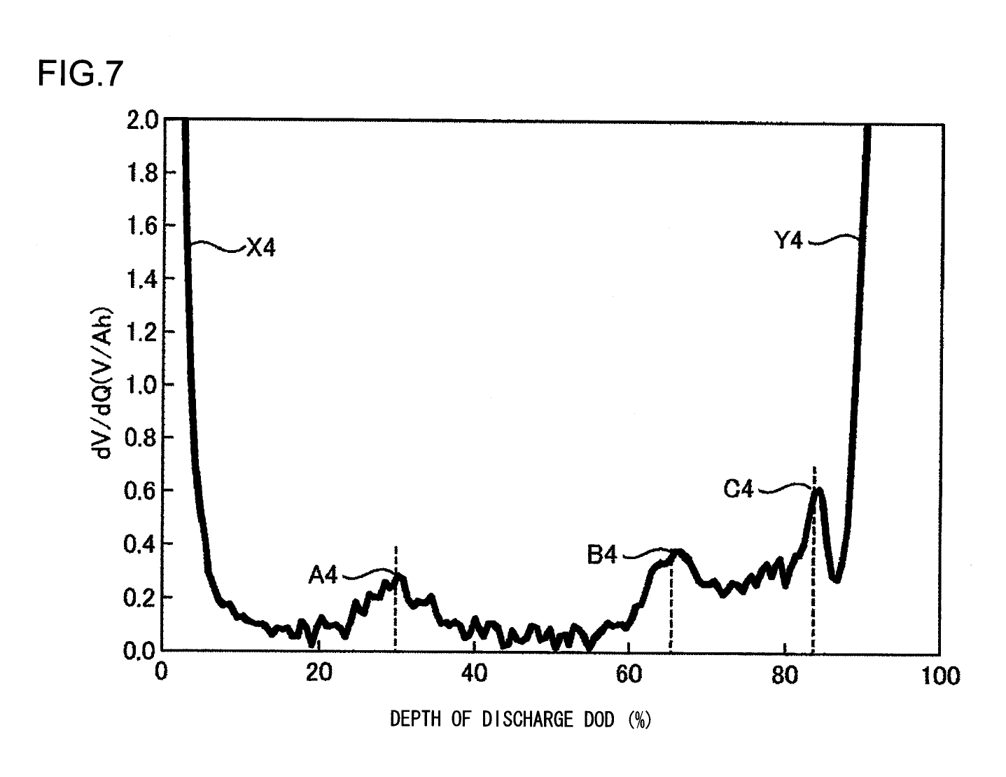

In FIG. 6, a Q-dV/dQ curve created based upon the discharge curve of FIG. 4 is shown. Moreover, in FIG. 7, a DOD-dV/dQ curve created based upon the discharge curve of FIG. 5 is also shown. In both FIG. 6 and FIG. 7, with the exception of the peaks X4 and Y4 at the two ends, the three main peak shapes A4, B4, and C4 appear. These three peaks A4, B4, and C4 correspond to the peak shapes A2, B2, and C2 shown in FIG. 3. In FIGS. 6 and 7, no peak shape equivalent to the peak shape E2 can be detected.

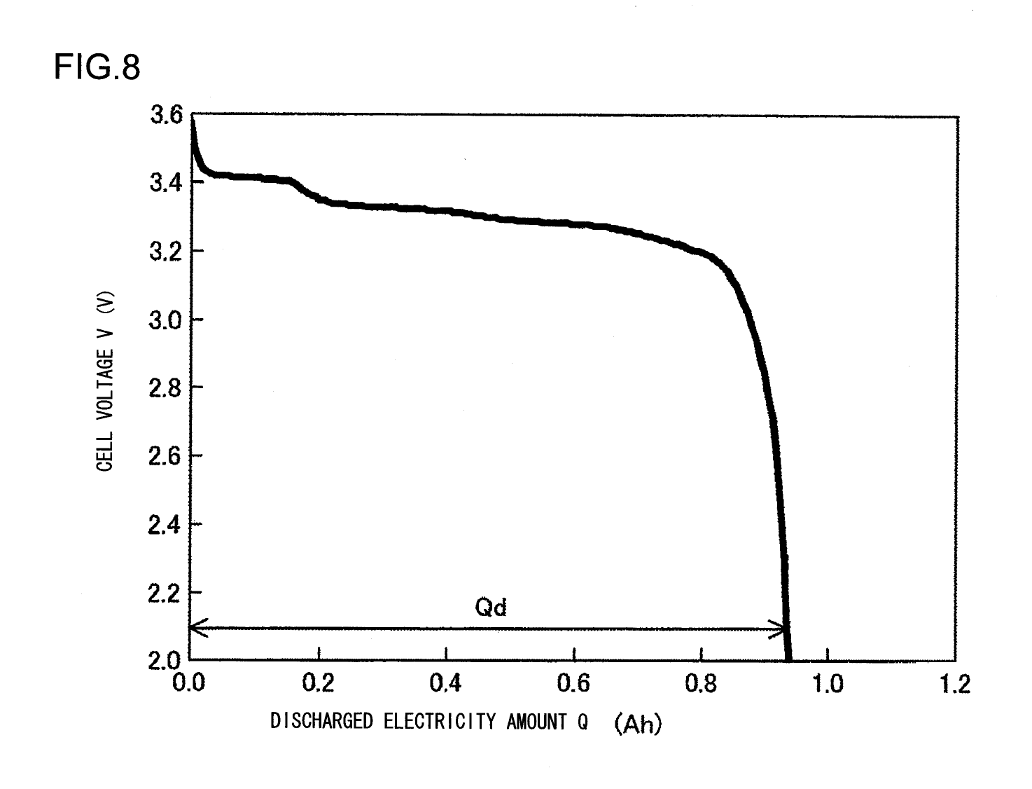

In FIG. 8, an example is shown of a discharge curve when the lithium secondary cell for which the discharge curve is shown in FIG. 4 is in an anomalously charged state. This discharge curve shows the relationship between the discharged electricity amount Q and the cell voltage V of this lithium cell that is in the anomalously charged state, when it is discharged at a constant discharge current from the fully charged state in which it has been charged up under the same conditions as when the discharge curve shown in FIG. 4 was obtained.

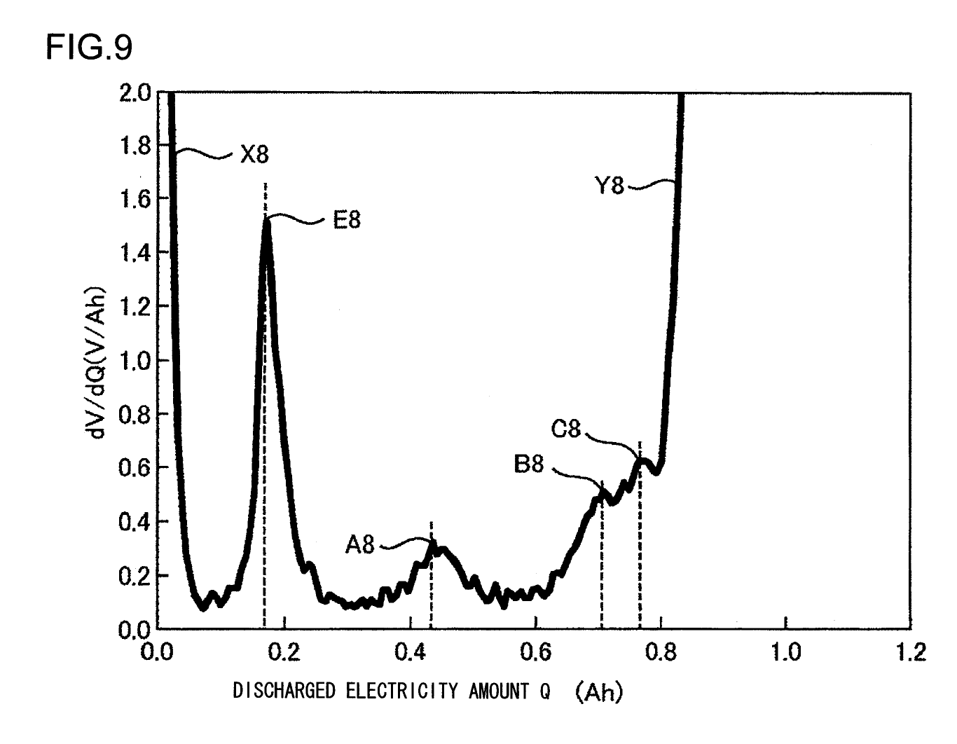

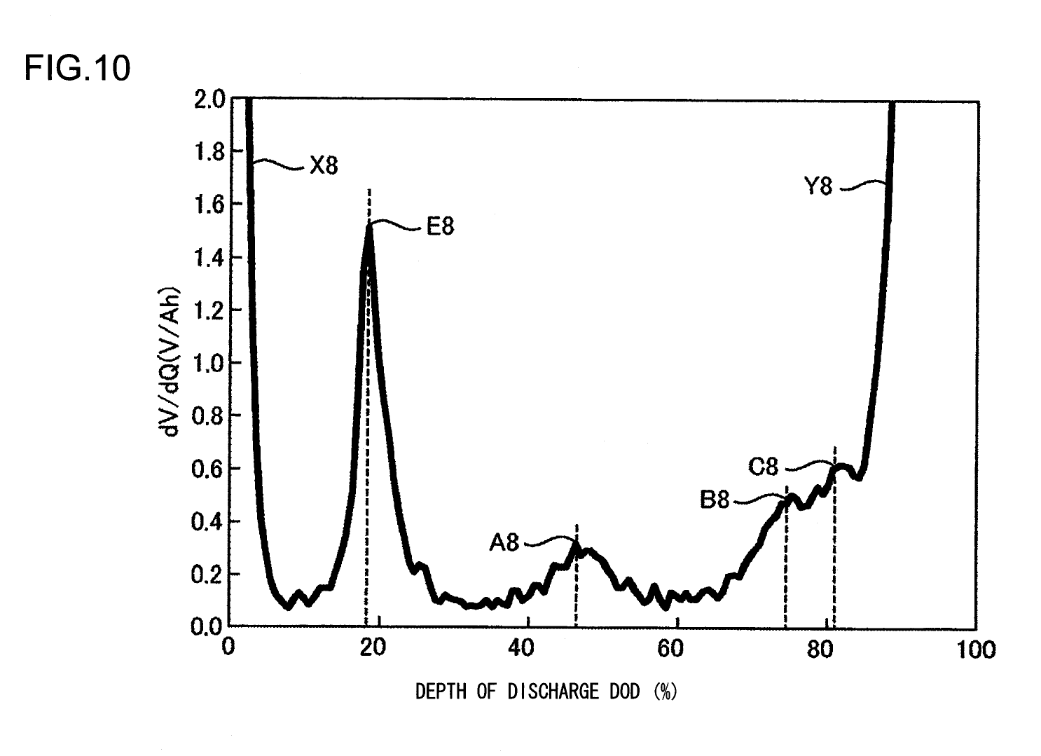

In FIG. 9, a Q-dV/dQ curve created based upon the discharge curve of FIG. 8 is shown. Moreover, in FIG. 10, a DOD-dV/dQ curve created based upon the discharge curve of FIG. 8 is also shown.

In FIGS. 9 and 10, with the exception of the peaks X8 and Y8 at the two ends, three main peak shapes appear: A8, E8, and a broad peak in which B8 and C8 are overlapped. The peak shape A8 is a shape that resembles the peak A4 in FIG. 4, and is a peak that indicates the same normal charged state. Moreover, the broad peak shape in which B8 and C8 are overlapped is one in which the peaks B4 and C4 of FIG. 4 are overlapped. On the other hand, the peak shape of E8 is a peak shape that did not appear in FIG. 4, and is a shape that resembles the peak E2 in FIG. 3. This peak E8 is one that indicates the anomalously charged state in which metallic lithium has precipitated out upon the negative electrode.

With the anomalously charged state detection device 100 according to the present invention, peak shapes like the peaks A4, B4, and C4 shown in FIGS. 6 and 7, which correspond to the normal state of the lithium secondary cell 200, are detected in the Q-dV/dQ curve generated by the CPU 131. If a peak shape like the peak E8 shown in FIGS. 9 and 10 is detected in the Q-dV/dQ curve where the discharged electricity amount Q or the depth of discharge DOD is smaller than these peak shapes, then it is determined that the cell is in the anomalously charged state. However, it is desirable to determine upon the anomalously charged state by taking the peak A4 as a reference, since sometimes it happens that B4 and C4 mutually overlap one another and become peak shapes like B8 and C8 in FIG. 10.

Moreover it would also be acceptable, in a similar manner to that described above, to arrange to determine the anomalously charged state, not only during discharge, but also from the peak shapes during charging. In this case, figures should be drawn in which the discharged electricity amount Q or the depth of discharge DOD shown along the horizontal axis in the discharge curves, the Q-dV/dQ curves, or the DOD-dV/dQ curves explained with reference to FIGS. 2 through 8 is replaced by the charged electricity amount or the depth of charge. In the curves made in this manner that show the differential value dV/dQ with respect to the charged electricity amount or the depth of charge, peaks A4, B4, and C4 are detected like those seen for a lithium secondary cell during normal conditions. If a peak E8 is detected where the charged electricity amount or the depth of charge is larger than those peak shapes, then it is decided that the cell is in the anomalously charged state. In the following it will be supposed that such a curve that shows the differential value dV/dQ with respect to the charged amount or the depth of charge in order to decide upon the anomalously charged state during charging is also termed a Q-dV/dQ curve or a DOD-dV/dQ curve.

It is desirable for data for various individual Q-dV/dQ curves or DOD-dV/dQ curves for lithium secondary cells to be created and to be stored according to combinations of the type of lithium secondary cell that is to be the subject of measurement, the charging and discharging currents, the surrounding temperature, and so on. It is desirable for data for various individual Q-dV/dQ curves or DOD-dV/dQ curves for lithium secondary cells that has been acquired at charging currents or discharging currents of 1/50 C to 1/5 C to be stored in the data storage unit 133, and it is more desirable for data acquired at charging currents or discharging currents of 1/20 C to 1/10 C to be stored. Here by 1 C is meant a current value that charges or discharges the rated capacity of the cell in one hour. For example, 50 hours are required to charge or to discharge the rated capacity of the cell at 1/50 C.

The cell data storage unit 133 may store in advance data for various individual Q-dV/dQ curves or DOD-dV/dQ curves for various lithium secondary cells corresponding to the type of the lithium secondary cell that is to be the subject of measurement, the charging and discharging currents, the surrounding temperature, and so on. Moreover, if 2 5 there is some change in the data, it is desirable for it to be possible to input new data. For example, an arrangement may be implemented in which data for various Q-dV/dQ curves or DOD-dV/dQ curves for various lithium secondary cells corresponding to the type of the lithium secondary cell that is to be the subject of measurement, the charging and discharging currents, the surrounding temperature, and so on is stored in an auxiliary 3 0 storage device 180 that includes an HDD, and in which it is possible to read out data that is needed from this auxiliary storage device 180 into the cell data storage unit for handling by the CPU 131. And, other than using an HDD, it would also be possible to employ a storage device in the auxiliary storage device 180 that can replay a transportable storage medium such as a CD-ROM, a CD-RW, a DVD-ROM, a USB memory, or the like.

In the following, the processing that is performed according to the data stored in the cell data storage unit 133 when a lithium secondary cell 200 that is in the perfectly charged state is discharged will be explained.

First, the CPU 131 controls the current control unit 140 through the interface 134, so that the current value that is measured by the current detection unit 120 becomes equal to the discharge current that was set by the condition input unit 170.

In each predetermined time period t, the CPU 131 calculates the discharged electricity amount Q of the lithium secondary cell 200 from the current value I that is detected by the current detection unit 120. And, on the basis of this electricity amount Q, the CPU 131 calculates the amount of change dQ of the electricity amount of the secondary cell 200 for each predetermined time period t. Moreover, on the basis of the voltage value V detected by the voltage detection unit 110, the CPU 131 calculates the change dV of the voltage of the secondary cell 200 each predetermined time period t. And it also calculates the differential value dV/dQ, which is the proportional change dV with respect to the change dQ.

Then, from these electricity amounts Q and the differential values dV/dQ, the CPU 131 generates a Q-dV/dQ curve for the lithium secondary cell 200 that is the subject of measurement. And this Q-dV/dQ curve that has thus been generated is stored in the measured data storage unit 132. Moreover, the Q-dV/dQ curve during normal conditions is read out from the cell data storage unit 133 that matches the type of the lithium secondary cell 200 set by the condition input unit 170, the discharge current, and the temperature of the surroundings of the lithium secondary cell 200 measured by the temperature detection unit 160.

The CPU 131 compares together the shape of the peaks of the Q-dV/dQ curve for the lithium secondary cell 200 that has been stored in the measured data storage unit 132 and the shape of the peaks of the Q-dV/dQ curve during normal conditions that has been read out from the cell data storage unit 133, and decides whether or not the secondary cell 200 is in an anomalously charged state on the basis of the result of this comparison.

If, in the Q-dV/dQ curve for the lithium secondary cell 200, the CPU 131 detects a peak like the peak E8 of FIG. 9, which is higher than the peaks A4 and A8 as shown in the examples of FIGS. 6 and 9, in the region where the discharged electricity amount Q is smaller than the peaks A4 and A8t, then it decides that the lithium secondary cell 200 is in an anomalously charged state, while, if it does not detect such a peak, then it decides that the cell 200 is in the normal state. And it outputs the result of this decision from the interface 134 to the display unit 150. It should be understood that if, as previously described, the discharged electricity amount Qd is acquired when discharge ends, then it would also be acceptable to arrange to use a DOD-dV/dQ curve as shown in the examples of FIGS. 7 and 10, instead of the Q-dV/dQ curve as shown in FIGS. 6 and 9, and to decide whether or not the lithium secondary cell 200 is in the anomalously charged state based thereupon.

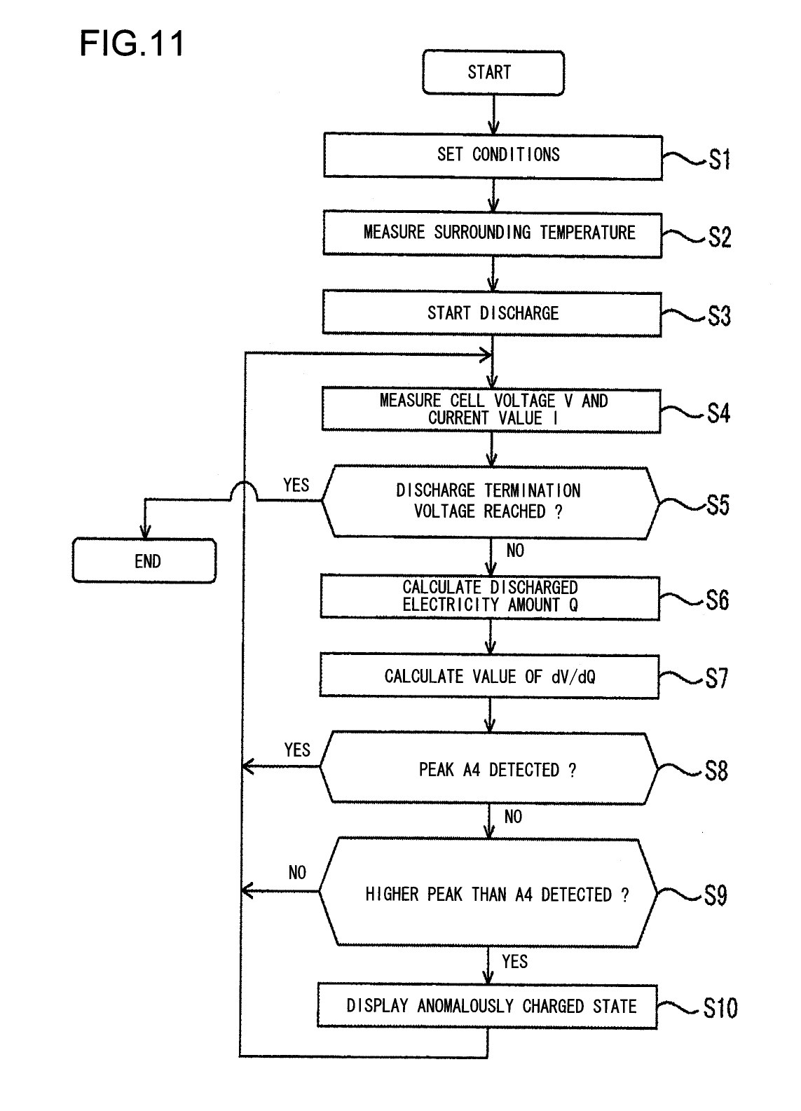

In FIG. 11, a flow chart is shown for the operation by the anomalously charged state detection device 100 to detect the anomalously charged state of the lithium secondary cell 200. As shown in FIG. 11, in a first step S1, the anomalously charged state detection device 100 sets conditions such as the discharge current, the discharge termination voltage, the type of the lithium secondary cell 200, and so on. Then in a step S2 it measures the temperature of the surroundings of the lithium secondary cell 200. And in a step S3 discharge from the lithium secondary cell 200 is started.

‘Then in a step S4 the cell voltage V and the current value I are measured. And in a step S5 a decision is made as to whether or not the voltage of the lithium secondary cell 200 has reached the discharge termination voltage. If the discharge termination voltage has been reached, then discharge is stopped, while if it has not been reached then the flow of control proceeds to a step S6.

In this step S6, the value of the discharged electricity amount Q is calculated. Then in a step S7 the value of the differential value dV/dQ is calculated. And in a step S8 the Q-dV/dQ curve or the DOD-dV/dQ curve of the lithium secondary cell 200 that was calculated by the CPU 131 and stored in the measured data storage unit 132, and the Q-dV/dQ curve or the DOD-dV/dQ curve during normal conditions that matches the conditions set in the step S1 and that is stored in the cell data storage unit 133 are compared together, and a decision is made as to whether or not a peak has been detected that corresponds to the peak A4 of FIGS. 6 and 7 or to the peak A8 of FIGS. 9 and 10. If such a peak is detected, then the flow of control returns to the step S4, and the processing of the steps S4 through S7 is repeated.

On the other hand, if no peak has been detected that corresponds to the peaks A4, A8, then the flow of control proceeds to a step S9. In this step S9, a decision is made as to whether or not a peak has been detected that is higher than A4 (A8), such as E8 in FIGS. 9 and 10. If no such peak has been detected, then the flow of control returns to the step S4, and the processing of the steps S4 through S8 is repeated. On the other hand, if a peak has been detected that corresponds to the peak E8, then the flow of control proceeds to a step S10, in which the fact that the cell 200 is in the anomalously charged state is displayed.

It is desirable for the lithium secondary cell 200 for which an anomalously charged state can be detected using the anomalously charged state detection device 100 of the present invention to be a lithium secondary cell that is manufactured in the following manner. With the use of material of the following types, it is possible to detect the anomalously charged state at high accuracy.

The negative electrode of the lithium secondary cell 200 is made from a negative electrode active material, a binder, and a current collector. With the present invention, as the negative electrode active material, it is desirable to use graphite for which the gaps between its surfaces (002), as obtained by an X-ray diffraction method, are d002=0.335 to 0.349 nm, since this is capable of occluding and emitting lithium electrochemically. It should be understood that, generally, it is often the case that the negative electrode active material is used in the powder state. Due to this, in the lithium secondary cell 200, by mixing a binder into the above described graphite in the powder state, the combined powder layer is adhered to the current collector at the same time that these powders are combined together. It is a condition that this current collector should be made from a material that is difficult to alloy with lithium, and copper foil is often used. The negative electrode may be made by adhering a negative electrode slurry in which the negative electrode active material, the binder, and an organic solvent are mixed together to the current collector by a doctor blade method or the like, and then drying out the organic solvent and press forming the negative electrode with a roll press.

On the other hand, the positive electrode of the lithium secondary cell 200 is made from a positive electrode active material, an electrically conductive material, a binder, and a current collector. A positive electrode active material that can be used with the present invention is an oxide containing lithium. For example, an oxide having a layer type structure such as LiCoO₂, LiNiO₂, LiMN_{1/3}Ni_{1/3}Co_{1/3}O₂, or LiMn_{0.4}Ni_{0.4}Co_{0.2}O₂, or a lithium manganese compound oxide having a spinel structure such as LiMn₂O₄ or Li₁₊ₓMn₂₋ₓO₄ may be used for this material. Moreover, it is possible to use a substance in which a portion of the Mn is replaced by some other element such as Al or Mg or the like, or a lithium containing transition metallic compound oxide having an olivine crystalline structure and that is chemically described as Li₁₊ₓM₁₋ₓPO₄ (where M is one or more transition metallic elements selected from Mn, Co, Ni, Cr, Al, Mg, and Fe). Among these, since the charging and discharging voltages of the positive electrode are flat, it is desirable to use a lithium containing transition metallic compound oxide having an olivine crystalline structure and that is chemically described as Li₁₊ₓM₁₋ₓPO₄ (where M is one or more transition metallic elements selected from Mn, Co, Ni, Cr, Al, Mg, and Fe).

Since the positive electrode active material generally has high resistance, in the lithium secondary cell 200, the electrical conductivity of the positive electrode active material is improved by mixing carbon powder, as the electrically conductive material, into the positive electrode active material. Since both the positive electrode active material and the electrically conductive material are powders, accordingly, by mixing a binder into these powders, a layer of the combined powders may be adhered to the current collector at the same time as these powders are combined together.

For the electrically conductive material, it is possible to use natural graphite, synthetic graphite, coke, carbon black, amorphous carbon, or the like. If the average particle diameter of the electrically conductive material is made to be smaller than the average particle diameter of the positive electrode active material powder, then it becomes easy for the electrically conductive material to adhere to the surfaces of the positive electrode active material particles, and it is often the case that the electrical resistance of the positive electrode decreases with the use of only a small amount of the electrically conductive material. Accordingly, it is preferable to select the electrically conductive material according to the average particle diameter of the positive electrode active material. It is desirable for the positive current collector to be made from a material that does not easily dissolve in the electrolyte, and aluminum foil is often used. The positive electrode may be manufactured by applying a slurry consisting of a mixture of the positive electrode active material, the electrically conductive material, the binder, and an organic solvent to the current collector by a doctor blade method using a blade. The positive electrode mixture and the current collector are adhered together by applying heat to the positive electrode that has been manufactured in this manner so as to evaporate the organic solvent, and by then press forming the positive electrode with a roll press.

Separators made from a macromolecular material such as polyethylene, polypropylene, ethylene tetrafluoride, or the like are inserted between the positive electrode and the negative electrode that have been manufactured as described above, and the electrolyte can be sufficiently well held by these separators and by the electrodes. Due to this, it is ensured that the positive electrode and the negative electrode are mutually electrically isolated, and that it is possible for lithium ions to transfer between the positive electrode and the negative electrode. In the case of a cylindrical cell, the electrode group is manufactured by inserting the separators between the positive electrode and the negative electrode and then winding them all together upon the same axis. It should be understood that, instead of separators, it would also be possible to employ a solid electrolyte or a gel electrolyte in sheet form, in which a lithium salt or a non aqueous electrolyte is held in a polymer such as polyethylene oxide (PEO), poly(methyl methacrylate) (PMMA), polyacrylonitrile (PAN), polyvinylidene fluoride (PVDF), polyvinylidene fluoride-hexafluoropropylene copolymer (PVDF-HFP), or the like. Moreover, if the electrodes are wound around two parallel axes, then it is also possible to obtain an electrode group that has an elliptical shape. And, in the case of a cell that is parallelepipedal, the electrode group may be manufactured by alternatingly laminating together positive electrodes and negative electrodes that are cut in short strips, with separators made of a macromolecular material such as polyethylene, polypropylene, ethylene tetrafluoride or the like being inserted between these electrodes. The present invention has no particular relationship to any of the structures for an electrode group described above, and may be applied to a lithium secondary cell 200 having an electrode group of any structure.

Furthermore, as a suitable electrolyte, a solvent consisting of any one of propylene carbonate, butylene carbonate, dimethyl carbonate, ethyl methyl carbonate, diethyl carbonate, methyl acetate, ethyl acetate, propyl acetate, methyl formate, ethyl formate, propyl formate, γ-butyrolactone, α-acetyl-γ-butyrolactone, α-methoxy-γ-butyrolactone, dioxolane, sulfolane, or ethylene sulfite, or containing any chosen combination of two or more thereof mixed together, may be used. A lithium salt electrolyte such as LiPF₆, LiBF₄, LiSO₂CF₃, LiN[SO₂CF₃]₂, LiN[SO₂ CF₂CF₃]₂, LiB[OCOCF₃]₄, or LiB[OCOCF₂CF₃]₄ or the like may be used, dissolved in this solvent at a volume density of from 0.5 to 2 M.

The electrode group that has been manufactured as described above is inserted into a cell container that is made from aluminum, stainless steel, nickel plated steel, or the like. Then electrolyte is filled into the container so that it permeates the electrode group. The shape of the cell container may be cylindrical, a flattened elliptical shape, parallelepipedal, or the like. A cell container of any shape may be selected, provided that it can satisfactorily house the electrode group.

Furthermore, the anomalously charged state test method for a lithium secondary cell according to the present invention may be practiced during periodical inspection of an electric automobile, a hybrid automobile, or the like. In this case, a lithium secondary cell that is mounted to an electric automobile or a hybrid automobile or the like is being charged or discharged, and a Q-dV/dQ curve or a DOD-dV/dQ curve may be drawn. It is possible to test the lithium secondary cell for the anomalously charged state by comparing this curve with a Q-dV/dQ curve or a DOD-dV/dQ curve of the normal state, and by determining from the result of this comparison whether or not a peak that indicates the anomalously charged state is present.

Furthermore, it is also possible to apply the anomalously charged state test method for a lithium secondary cell according to the present invention to a plurality of lithium secondary cells included in a cell module in which this plurality of lithium secondary cells are connected in series or in series-parallel, such as is used in a hybrid automobile or the like. In this case, the cell voltage of each of the lithium secondary cells is measured, the value of the current flowing in each group of cells connected together in series is measured, and a Q-dV/dQ curve or a DOD-dV/dQ curve is drawn for each of the lithium secondary cells. Each of these is compared with a corresponding Q-dV/dQ curve or a corresponding DOD-dV/dQ curve of the normal state, and it is possible to test the corresponding lithium secondary cell for the anomalously charged state by determining from the result of this comparison whether or not a peak that indicates the anomalously charged state is present.

As described above, the anomalously charged state detection device for a lithium secondary cell and the anomalously charged state test method of the present invention may appropriately be applied to testing of a lithium secondary cell.

What is claimed is:

1. An anomalously charged state detection device for a lithium secondary cell that has a positive electrode, a negative electrode, and an electrolyte including lithium ions, and that is capable of being electrically charged and discharged, comprising:
a voltage detection unit that detects the voltage V of the lithium secondary cell;
a current detection unit that detects the current flowing in the lithium secondary cell;
a calculation unit that calculates the electricity amount Q charged into or discharged from the lithium secondary cell on the basis of the current value detected by the current detection unit and a differential value dV/dQ, which is the proportion between the change dV of the voltage V and the change dQ of the electricity amount Q, for each predetermined time period t on the basis of the electricity amount Q and the voltage V, and that obtains a Q-dV/dQ curve for the lithium secondary cell;
a measured data storage unit that stores the Q-dV/dQ curve for the lithium secondary cell obtained by the calculation unit;
a cell data storage unit that stores a Q-dV/dQ curve for the lithium secondary cell during normal conditions; and
a control unit that decides that the lithium secondary cell is in an anomalously charged state if, in the Q-dV/dQ curve for the lithium secondary cell stored by the measured data storage unit, a peak is present that is different from a peak that appears in the Q-dV/dQ curve during normal conditions stored by the cell data storage unit.

2. An anomalously charged state detection device for a lithium secondary cell according to claim 1, wherein:
the negative electrode of the lithium secondary cell includes graphite; and
in order, a first peak, a second peak, and a third peak appear in the Q-dV/dQ curve during normal conditions, at positions where the amount of lithium ions occluded in the graphite changes from high to low.

3. An anomalously charged state detection device for a lithium secondary cell according to claim 2, wherein:
when the lithium secondary cell is discharged from the charged state, the control unit decides that the lithium secondary cell is in the anomalously charged state if a higher peak in the differential value dV/dQ than the first peak has been detected in a region in the Q-dV/dQ curve of the lithium secondary cell where the electricity amount Q is smaller than the first peak.

4. An anomalously charged state detection device for a lithium secondary cell according to claim 2, wherein:
when the lithium secondary cell is charged from the discharged state, the control unit decides that the lithium secondary cell is in the anomalously charged state if a higher peak in the differential value dV/dQ than the first peak has been detected in a region in the Q-dV/dQ curve of the lithium secondary cell where the electricity amount Q is larger than the first peak.

5. An anomalously charged state detection device for a lithium secondary cell according to claim 1, wherein:
the anomalously charged state is a state in which metallic lithium has been precipitated out upon the negative electrode of the lithium secondary cell.

6. An anomalously charged state detection device for a lithium secondary cell according to claim 1, wherein:
the negative electrode of the lithium secondary cell includes a negative electrode active material containing graphite for which the gaps between its surfaces (002), as obtained by an X-ray diffraction method, are d002=0.335 to 0.349 nm.

7. An anomalously charged state detection device for a lithium secondary cell according to claim 1, wherein:
the positive electrode of the lithium secondary cell includes a positive electrode active material containing at least a lithium containing transition metallic compound oxide having an olivine crystal structure.

8. An anomalously charged state detection device for a lithium secondary cell according to claim 7, wherein:
the positive electrode active material includes a lithium containing transition metallic compound oxide having an olivine crystalline structure, the transition metallic compound oxide being chemically described as Li₁₊ₓM₁₋ₓPO₄ (where M is one or more transition metallic elements selected from Mn, Co, Ni, Cr, Al, Mg, and Fe).

9. An anomalously charged state detection device for a lithium secondary cell according to claim 1, wherein:
the cell data storage unit stores in advance a plurality of Q-dV/dQ curves during normal conditions for various current values; and
the control unit selects, from among the plurality of Q-dV/dQ curves during normal conditions stored by the cell data storage unit, the Q-dV/dQ curve during normal conditions that corresponds to the current value detected by the current detection unit, and decides whether or not the lithium secondary cell is in the anomalously charged state on the basis of this Q-dV/dQ curve during normal conditions that has been selected.

10. An anomalously charged state detection device for a lithium secondary cell according to claim 1, further comprising a temperature measurement unit that measures the temperature of the surroundings of the lithium secondary cell; and wherein:
the cell data storage unit stores in advance a plurality of Q-dV/dQ curves during normal conditions for various temperatures of the surroundings of the lithium secondary cell; and
the control unit selects, from among the plurality of Q-dV/dQ curves during normal conditions stored by the cell data storage unit, the Q-dV/dQ curve during normal conditions that corresponds to the temperature of the surroundings of the lithium secondary cell measured by the temperature measurement unit, and decides whether or not the lithium secondary cell is in the anomalously charged state on the basis of this Q-dV/dQ curve during normal conditions that has been selected.

11. An anomalously charged state test method for a lithium secondary cell that has a positive electrode, a negative electrode, and an electrolyte including lithium ions, and that is capable of being electrically charged and discharged, comprising:
acquiring the current value and the voltage value V of the lithium secondary cell for each predetermined time period;
calculating the electricity amount Q charged into or discharged from the lithium secondary cell on the basis of the current value of the lithium secondary cell;
calculating a differential value dV/dQ, which is the proportion between the change dV of the voltage V and the change dQ of the electricity amount Q, for each predetermined time period t on the basis of the electricity amount Q and the voltage V;
obtaining a Q-dV/dQ curve for the lithium secondary cell; and
deciding that the lithium secondary cell is in an anomalously charged state if, in the Q-dV/dQ curve for the lithium secondary cell, a peak is present that is different from a peak that appears in a Q-dV/dQ curve during normal conditions for the lithium secondary cell that has been acquired in advance.

12. An anomalously charged state test method for a lithium secondary cell according to claim 11, wherein:
the negative electrode of the lithium secondary cell includes graphite; and
in order, a first peak, a second peak, and a third peak appear in the Q-dV/dQ curve during normal conditions, at positions where the amount of lithium ions occluded in the graphite changes from high to low.

13. An anomalously charged state test method for a lithium secondary cell according to claim 12, wherein:
when the lithium secondary cell is discharged from the charged state, it is decided that the lithium secondary cell is in the anomalously charged state if a higher peak in the differential value dV/dQ than the first peak has been detected in a region in the Q-dV/dQ curve of the lithium secondary cell where the electricity amount Q is smaller than the first peak.

14. An anomalously charged state test method for a lithium secondary cell according to claim 12, wherein:
when the lithium secondary cell is charged from the discharged state, it is decided that the lithium secondary cell is in the anomalously charged state if a higher peak in the differential value dV/dQ than the first peak has been detected in a region in the Q-dV/dQ curve of the lithium secondary cell where the electricity amount Q is larger than the first peak.

15. An anomalously charged state test method for a lithium secondary cell according to claim 11, wherein:
the anomalously charged state is a state in which metallic lithium has been precipitated out upon the negative electrode of the lithium secondary cell.

16. An anomalously charged state test method for a lithium secondary cell according to claim 11, wherein:
the negative electrode of the lithium secondary cell includes a negative electrode active material containing graphite for which the gaps between its surfaces (002), as obtained by an X-ray diffraction method, are d002=0.335 to 0.349 nm.

17. An anomalously charged state test method for a lithium secondary cell according to claim 11, wherein:
the positive electrode of the lithium secondary cell includes a positive electrode active material containing at least a lithium containing transition metallic compound oxide having an olivine crystal structure.

18. An anomalously charged state test method for a lithium secondary cell according to claim 17, wherein:
the positive electrode active material includes a lithium containing transition metallic compound oxide having an olivine crystalline structure, the transition metallic compound oxide being chemically described as Li₁₊ₓM₁₋ₓPO₄ (where M is one or more transition metallic elements selected from Mn, Co, Ni, Cr, Al, Mg, and Fe).

19. An anomalously charged state test method for a lithium secondary cell according to claim 11, wherein:
a plurality of Q-dV/dQ curves during normal conditions are stored in advance for various current values of charging or discharging; and
from among the plurality of Q-dV/dQ curves during normal conditions, the Q-dV/dQ curve during normal conditions that corresponds to the current value flowing in the lithium secondary cell is selected, and it is decided whether or not the lithium secondary cell is in the anomalously charged state on the basis of this Q-dV/dQ curve during normal conditions that has been selected.

20. An anomalously charged state test method for a lithium secondary cell according to claim 11, wherein:
a plurality of Q-dV/dQ curves during normal conditions for various temperatures of the surroundings of the lithium secondary cell are stored in advance; and
from among the plurality of Q-dV/dQ curves during normal conditions, the Q-dV/dQ curve during normal conditions that corresponds to the temperature of the surroundings of the lithium secondary cell is selected, and it is decided whether or not the lithium secondary cell is in the anomalously charged state on the basis of this Q-dV/dQ curve during normal conditions that has been selected.
